(19) United States
(12) Patent Application Publication
(10) Pub. No.: US 2023/0376745 A1
(43) Pub. Date: Nov. 23, 2023

(54) Automated Selection of Neural Architecture Using a Smoothed Super-Net

(71) Applicant: Arm Limited, Cambridge (GB)

(72) Inventors: Kartikeya Bhardwaj, San Jose, CA (US); Guihong Li, Austin, TX (US); Naveen Suda, Fremont, CA (US); Milos Milosavljevic, Austin, TX (US); Danny Daysang Loh, Menlo Park, CA (US)

(73) Assignee: Arm Limited, Cambridge (GB)

(21) Appl. No.: 17/751,089

(22) Filed: May 23, 2022

(51) Int. Cl. G06N 3/08; G06N 3/04

(52) U.S. Cl. CPC G06N 3/08; G06N 3/04

(57) ABSTRACT

A mechanism to control the stability and performance of weight-sharing methods for designing neural networks is provided. Network weights and architecture parameters of a super-net, including multiple sub-networks, are adjusted to reduce a loss determined, at least in part, from a sum, over layers of the sub-network, of measures of smoothness based on network weights in the layers. A sub-network of the super-net is selected dependent upon the adjusted architectural parameters.

### BACKGROUND

Neural Architecture Search (NAS) has emerged as a state-of-the-art method that exploits Artificial Intelligence (AI) to automatically design deep neural networks. The method involves searching between a large number of architectures to find an architecture that provides the desired combination of accuracy and efficiency. Early search methods required large amounts of computation. However, approaches such weight-sharing NAS and Differentiable NAS can greatly reduce the computation time.

Weight-sharing NAS first designs a large network called a super-net that contains many possible sub-networks. The problem is to find an appropriate sub-network that provides high accuracy for a chosen task. In weight-sharing NAS, different sub-networks share the same weights, and all sub-networks are trained jointly. This removes the main limitation of earlier NAS methods, which typically sampled individual sub-networks and trained them independently in parallel over many processors.

Differentiable NAS (DNAS) is a different class of NAS techniques. In DNAS, a super-net containing all possible sub-networks is trained jointly with architecture parameters (α-parameters). A super-net assembles all candidate architectures into a weight sharing network, with each architecture option corresponding to one sub-network. By training the sub-networks simultaneously with the super-net, different architectures can directly inherit the weights from the super-net for evaluation and deployment. This approach eliminates the extremely large cost of training or fine-tuning each architecture option individually.

The architecture parameters (α-parameters) in DNAS represent the importance, or probability, of different decision choices at various locations inside a super-net. Specifically, training a regular deep network involves updating weight parameters using an optimization algorithm, such as stochastic gradient descent (SGD). However, DNAS not only updates the actual weights (of operations like two-dimensional convolutions, etc.), but also the architecture parameters. Hence, weights and architecture parameters are trained jointly. At the end of training, operations corresponding to maximum architectural parameter values are chosen. The process involves a final training stage for the architecture determined by maximum architectural parameters.

A disadvantage of weight-sharing NAS, whether using sub-network sampling or stochastic gradient descent, is that the performance of a sub-network trained as part of the super-net may be very different to the performance of the sub-network when individually trained. In addition, in DNAS, the learning process may become unstable.

### BRIEF DESCRIPTION OF THE DRAWINGS

The accompanying drawings provide visual representations which will be used to describe various representative embodiments more fully and can be used by those skilled in the art to better understand the representative embodiments disclosed and their inherent advantages. In these drawings, like reference numerals identify corresponding or analogous elements.

FIG. 1 is a simplified block diagram of a data processor for automated selection of neural network architecture, in accordance with various embodiments of the present disclosure.

FIG. 2 is a block diagram of a system for training a sub-network, selected from a super-net, in accordance with various embodiments of the present disclosure.

FIG. 3 is a block diagram showing the use of a selected and trained sub-network to perform a designated task.

FIG. 4 is a block diagram of an operational block of a super-net, in accordance with various embodiments of the present disclosure.

FIG. 5 is a further block diagram of an operational block of a super-net, in accordance with various embodiments of the present disclosure.

FIG. 6 is a block diagram of three consecutive blocks of a neural network architecture, in accordance with various embodiments of the present disclosure.

FIGS. 7A and 7B are graph illustrations of a loss function L for a deep network, as a function of the input data, in accordance with various embodiments of the present disclosure.

FIGS. 8A and 8B are graph illustrations of a loss function L for networks as a function of the trainable super-net parameters, in accordance with various embodiments of the present disclosure.

FIG. 9 is a flow chart of a computer-implemented method of automated design of a neural network, in accordance with various embodiments of the present disclosure.

FIG. 10 is a flow chart of a computer-method 1000 of determining a loss function dependent upon the lack of smoothness of sub-network layers in a neural network, in accordance with various embodiments of the present disclosure.

FIG. 11 shows estimated Lipschitz constant for layers of an example trained network, in accordance with various embodiments of the present disclosure.

FIG. 12 shows test accuracy of a network trained in accordance with various embodiments of the present disclosure.

### DETAILED DESCRIPTION

The various apparatus and devices described herein provide mechanisms for automated design of neural network architecture or topology. In particular, mechanisms are disclosed for automated selection of a sub-network from a super-net containing multiple candidate sub-networks.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar or corresponding parts in the several views of the drawings. For simplicity and clarity of illustration, reference numerals may be repeated among the figures to indicate corresponding or analogous elements.

The present disclosure relates to a mechanism to control the stability and performance of weight-sharing methods for designing neural networks. By way of example, a weight-sharing differentiable neural architecture search (DNAS) design method is described where weights are shared across multiple sub-networks during the training of a super-net. The approach recognizes that sharpness/smoothness of network layers is a fundamental property that can determine the stability/convergence of weight-sharing NAS. Previously, smoothness measures have only been defined for differences in the functions represented by a given network with respect to training and test datasets (due to differences in input data distributions between training and test sets). In contrast, the disclosed approach uses a measure of smoothness, or lack thereof, defined for the loss landscapes of various sub-networks in the architecture space of a super-net. The approach recognizes that different sub-networks have different distributions of architecture-parameters (α-parameters) and weight-parameters (W-parameters).

As discussed in greater detail below, a conventional weight-sharing NAS problem is augmented with an additional loss function that specifically pushes the individual sub-networks to become smoother. This new loss function approximates the Lipschitz constant of the neural network and minimizes this loss jointly for all sub-networks sampled for a batch of data.

Experimental results are presented that demonstrate the advantages of the proposed approach and clearly show that the sharpness metric (approximate Lipschitz) is noticeable reduced while the accuracy improves. Results also show that the disclosed approach results in networks with higher accuracy at a similar hardware cost.

Weight-sharing NAS has become very important for hardware-aware NAS. Hardware-aware NAS is an automated technique to build neural networks and produces very efficient deep networks for a given hardware. However, instability in weight-sharing NAS is a critical problem. In addition to NAS, weight-sharing also presents significant challenges to other well-known and challenging problems like multi-task learning, multi-modal learning, etc.

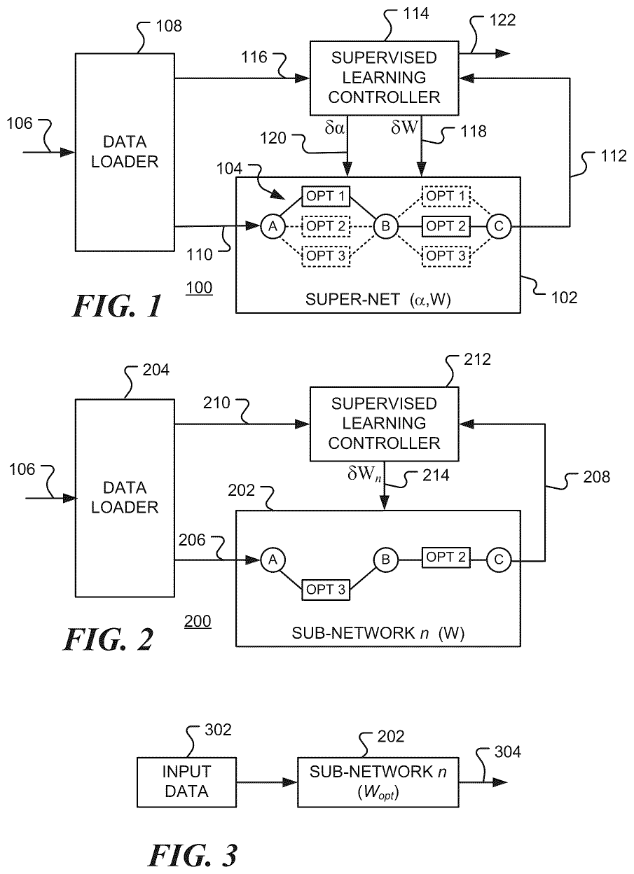

FIG. 1 is a simplified block diagram of a data processor 100 for Neural Architecture Search (NAS). A super-net 102 is a neural network that includes a number of sub-networks 104. In the simplified example shown, each sub-network 104 corresponds to selected path from node A to node C. The path segment from node A to node B has three options (designated by operational blocks OPT 1, OPT 2 and OPT 3), each corresponding to a selectable operation on the input data. Similarly, the path segment from node B to node C has three options. Thus, in this simplified example there are nine selectable sub-networks, and the objective is to select the sub-network with the best performance for a designated task. In practice, there may be any number of nodes and any number of selectable operations between them. Each operation may include one or more network layers, such a convolutional layer, max-pooling layers, etc.

Data processor 100 may be implemented, for example, on a general-purpose processor, graphics processing unit, vector processor or array processor. The super-net may be implemented using custom hardware or a combination of custom and general-purpose hardware.

The present disclosure relates to improved mechanisms for automated selection of a sub-network, from super-net 102, for a chosen task or application. Training data 106 is provided for the chosen task. The training data includes a set of training inputs and corresponding training outputs. During training, a data loader 108 is configured to supply training inputs 110 to super-net 102 to produce outputs 112. For example, output 112 may be a label classifying the training input 110.

Outputs 112 are passed to supervised learning controller 114. Output 112 is compared to corresponding desired training output 116 in supervised learning controller 114. Network weights, W, of network 102 are adjusted by an amount δW (118), to reduce a cost function computed from a difference between training output 116 and network output 112.

One approach for Neural Architecture Search (NAS) is weight-sharing NAS, discussed above. In this approach, the performances of different combinations of sub-networks are compared to select a final sub-network.

Another approach is differentiable NAS (DNAS). DNAS also uses a super-net containing all possible sub-networks. However, the search space is relaxed to be continuous. This enables the architecture to be optimized by gradient descent. A super-net containing all possible sub-networks is trained jointly with architecture parameters (α-parameters). The super-net includes paths with selectable operations such as convolution, max-pooling, average pooling, etc. The architecture parameters represent the importance, or probability, of different architecture choices at various locations inside a super-net. Training a regular deep network involves updating weight parameters using an optimization algorithm, such as stochastic gradient descent (SGD). DNAS not only updates the actual weights of operations, but also the architecture parameters. In FIG. 1, the change to the architecture parameters is shown as vector δα (120). Hence, weights and architecture parameters are trained jointly. After training, the sub-network corresponding to maximum architectural parameter values are selected. The selected sub-network, output at 122, describes the final network architecture for the chosen application.

Both gradient-based training, such as DNAS, and sample-based NAS, make use of a measure of performance referred to as a “loss function,” or simply a “loss.” The present disclosure provides a loss function that enables selection of a final network architecture having improved performance.

One embodiment of the disclosure is a data processor that includes a super-net including a plurality of selectable sub-networks, the super-net including network weights and architecture parameters, a data loader configured to access one or more batches of training data for a designated task, and a supervised learning controller configured to train network weights and architectural parameters of the super-net. The training is accomplished by providing training inputs of the training data to sample sub-networks of the super-net to generate sub-network outputs, accumulating a loss over the sample sub-networks, the accumulated loss based, at least in part, on a sum, over layers of a sub-network, of measures of smoothness based on network weights in the layers, and adjusting network weights and architectural parameters of the super-net to reduce the accumulated loss. The supervised learning controller is also configured to select a sub-network of the plurality of sub-networks dependent upon the adjusted architectural parameters and output a description of the selected sub-network. As described below, the accumulated loss may combine a first loss and a second loss, where the first loss is based on a difference between an output of a sample sub-network, generated from a training input, and a corresponding training output, and the second loss is a product of a smoothness scale factor and the sum, over layers of the sample sub-network, of measures of smoothness based on network weights in the layers.

Embodiments of the present disclosure may be implemented in a system comprising one or more computers and one or more storage devices storing instructions that, when executed by the one or more computers, cause the one or more computers to select a neural network architecture, as described below.

FIG. 2 is a block diagram of a system 200 for training a sub-network 202, selected as described above. The training process, described above, adjusts weights of the super-net and the weights are used in the sub-networks. These weights may not be optimal for the final architecture. In a further training stage for the selected architecture, shown in FIG. 2, training data 106 is accessed by data loader 204 to provide input data 206 to selected sub-network 202. In this example, the selected sub-network includes operation OPT 3 between nodes A and B and the operation OPT 2 between nodes B and C. Network output 208 is compared to training output 210 in supervised learning controller 212. The sub-network weights are adjusted by an amount δWₙ, 214, to reduce a cost function dependent upon a difference between training output 210 and network output 208. In this way, the network weights of selected sub-network 202 are optimized for the chosen task.

FIG. 3 is a block diagram showing the use of the selected and trained sub-network 202 to perform the designated task. In response to an input 302, the trained sub-network generates an output 304. The output may be a label classifying the input, for example.

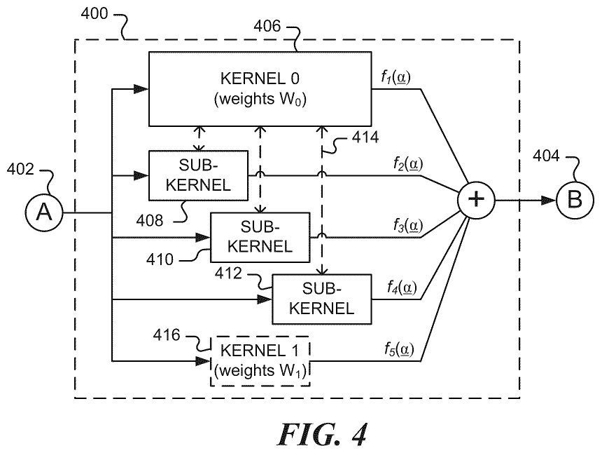

FIG. 4 is a block diagram of an operational block 400 that couples between nodes 402 and 404 of a super-net. Operational block 400 includes convolutional neural network (CNN) 406 with kernel weights W₀, and smaller CNNs 408, 410 and 412. As depicted by broken lines 414, smaller CNNs 408, 410 and 412 share at least some weights with CNN 406. Thus, the amount of computation needed to train the operational block, and select the architecture, is much reduced. Optionally, block 400 may contain one or more CNNs 416 that do not share weights with CNN 406. In the simple example shown, operational block 400 contains a single layer. In general, a block may contain a single layer or multiple layers.

CNN 406 and smaller CNNs 408, 410 and 412 are depicted as being combined with weighting value fᵢ (\vec{α}), where \vec{α}is a vector of architecture parameters. These parameters may represent relaxed selections or probabilities, for example. In one embodiment, the weighting value is a normalized non-negative linear weight, fᵢ (\vec{α})=αᵢ/Σₙαₙ. In a further embodiment, the weighting value is a soft-max value fᵢ (\vec{α})=exp(αᵢ)/Σₙexp(αₙ). Other weighting values may be used without departing from the present disclosure. The final architecture is obtained by setting one a to unity and the other to zero.

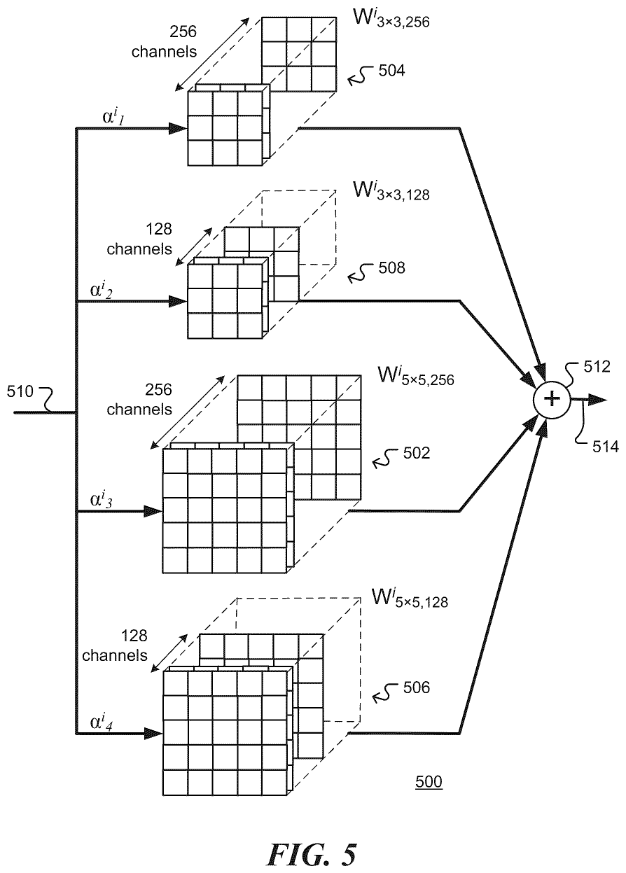

A block 400 may be configured to select a kernel size and number of channels for a layer. This may be achieved using a super-kernel, which results in a very efficient NAS method. The concept of super-kernel is depicted in FIG. 5.

FIG. 5 shows an architecture block 500, with index i, having four options. Each option is a convolutional neural network (CNN). Option 502 is a super-kernel that contains the largest kernel (5×5 in this example) and the maximum possible number of channels (256 in this example). Appropriate α-parameters are used to select various options within this kernel. In the example shown, the 5×5 kernel contains a 3×3 kernel, and the 256 channels include a sub-set of 128 channels. Block 500 provides four options: W_{5×5, 256} (502), W_{3×3, 256} (504), W_{5×5, 128} (506) and W_{3×3, 128} (508). One architecture parameter, α, is assigned to each of these options. The options receive the same input 510 and their outputs, weighted by the architecture parameters α, are combined at 512 to give overall output 514. When training the super-net, the weights for the middle 3×3 are shared by both the 3×3 sub-network and the 5×5 sub-network and the weights for the 128 channel options are shared with the 128 and 256 channel options. An option is selected by setting its α value to 1 and setting the other α values to zero. However, the block may be trained for continuous values of α, with the final option having the largest value being selected. A direct advantage of using a single super-kernel is that it saves significant computation and memory when training the super-net. This results in significant time savings during the search process.

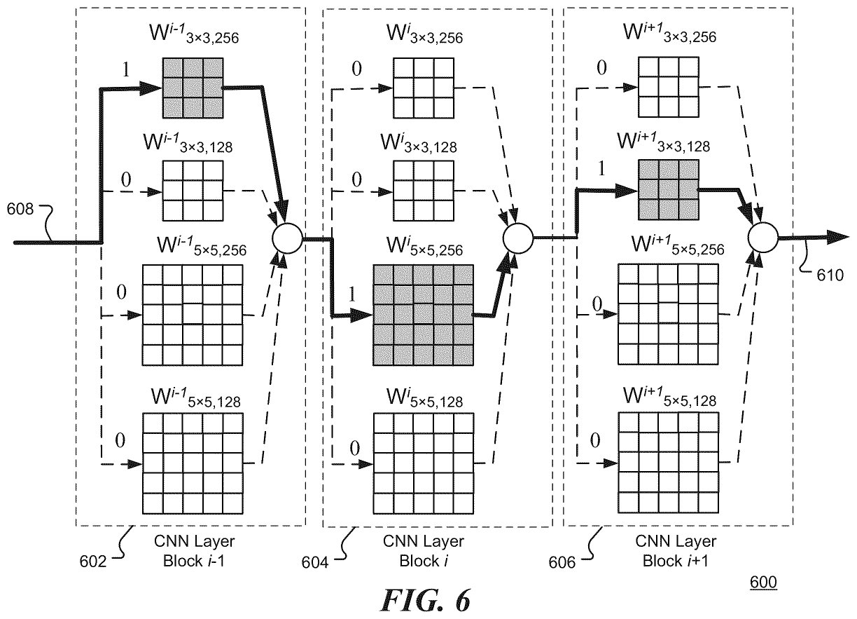

FIG. 6 shows three consecutive blocks of a neural network architecture 600. With four options in each block, there are 4×4×4=64 sub-networks represented, each corresponding to a path through the architecture 600. NAS is used to select a single sub-network from the 64 options. In each block, the network weights of the super kernel in each block are shared with the other CNNs in the same block and they are trained together. They may be trained by relaxing the architecture parameters and adjusting them using a gradient descent scheme. Alternatively, the weights may be trained together by sampling multiple sub-networks to update weight parameters. In the example shown in FIG. 6, the option with a 3×3 kernel and 256 channels (with weights W_{3×3,256}ⁱ⁻¹) is chosen for block 602, the option with a 5×5 kernel and 256 channels (with weights W_{5×5,256}ⁱ⁻¹)) is chosen for block 604, the option with a 3×3 kernel and 128 channels (with weights W_{3×3,128}ⁱ⁻¹) is chosen for block 606. The path through the selected sub-network is shown by the solid line from input 608 to output 610.

Various NAS techniques, including sampling-based searches and gradient-based searches, use weight-sharing. However, while weight-sharing produces highly efficient NAS solutions, there is a major problem associated with this technique: namely, since same set of weights are parts of different sub-networks, weight-sharing can lead to a severe instability in gradients when training the super-nets. For instance, say for a given layer, 128 channels are sampled for a first training batch and 256 channels at the same layer are sampled for the next training batch. In this case, since the first 128 channels are common for both sub-network samples, they are being trained as part of different functions for two different training batches of data. The present disclosure recognizes that training the same set of weights with different functions can result in conflicting gradient updates. For example, the gradients for two sub-networks could be orthogonal, or in opposite directions. As a result, weight-sharing NAS can result in significant instability in the training process due to uncorrelated gradient updates. This, in turn, can result in poor convergence during super-net training and even convergence to suboptimal solutions.

In accordance with the present disclosure, a mechanism is provided to improve the stability of weight-sharing techniques. A smoothness-based loss term is added for evaluating performance while training a super-net. The loss term penalizes sub-networks with lower smoothness. As a result, the optimization landscape of various sub-networks in the given super-net becomes smoother (or flatter), resulting in lower discrepancy between the loss functions of different sub-networks. The gradients of various sub-networks automatically become more stable, leading to significantly better training convergence and accuracy in the search. In one embodiment, the smoothness-based loss term is related to Lipschitz continuity, which is a measure of a function's flatness (a lower Lipschitz constant indicates higher smoothness or flatness).

The provision of a smoothness-based loss term addresses the problem of instability in weight-sharing DNAS by making the optimization landscape of sub-networks smoother. Consequently, there is lower discrepancy among the gradients of different sub-networks. This, in turn, results in stable gradients, better convergence, and higher accuracy.

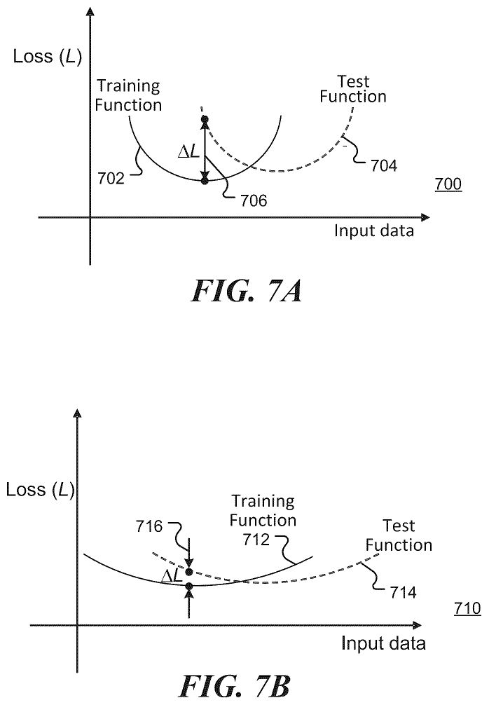

FIG. 7A is a graph 700 illustrating a loss function L for a deep network as a function of the input data. Loss 702 shows a sharp minimum as a function of training inputs. Loss 704 shows a similar sharp minimum as a function of validation or test inputs. Due to the distribution shift between training and testing data, the network has poor test accuracy, indicated by the increase in loss ΔL (706). In contrast, if the network reaches a flat minimum, as illustrated by graph 710 in FIG. 7B, there is very small difference between training loss 712 and testing loss 714. This is depicted by smaller loss increase ΔL (716). Thus, when deep learning optimization results in a sharp minimum on the training set, then, the network achieves poor accuracy on the test set. Whereas, if the minimum is flat, the network achieves good accuracy on the test set. This sharpness of a minimum has been used as a metric to indicate generalization performance of deep neural networks where no architecture search is performed.

Training a conventional deep neural network, there is a distribution shift since training and testing datasets belong to slightly different distributions. The present disclosure recognizes that, in a weight-sharing NAS scenario, the super-net and all sub-networks represent a distribution shift in the neural network architecture space. That is, the architectures and their weights belong to slightly different distributions in the space of all possible sub-networks. A new notion of sharpness is defined in the space of neural network architectures. This provides a metric for the stability of weight-sharing NAS.

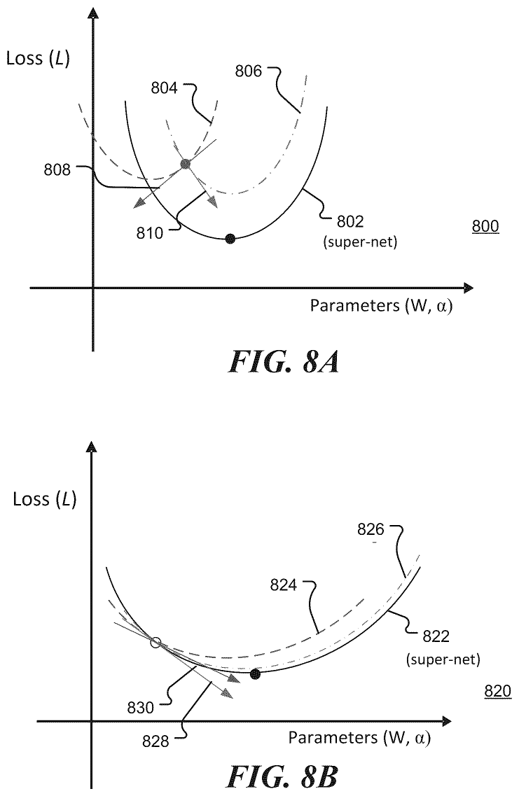

FIG. 8A is a graph 800 illustrating a loss function L for networks as a function of the trainable super-net parameters: W (network weights) and a (architecture parameters). In FIG. 7A, the loss (L) is shown as a function of input data, whereas in FIG. 8A the loss is a function of the super-net parameters. Curve 802 shows the loss for a super-net, curve 804 shows the loss for a first sub-network and curve 806 shows a curve for a second sub-network. FIG. 8A illustrates how a lack of smoothness in the sub-networks loss landscapes can result in orthogonal or completely uncorrelated gradients. For example, gradient 808 for sub-network 804 is substantially orthogonal to gradient 810 for sub-network 806.

FIG. 8B is a graph 820 that shows loss curves for a super-net 822, a first sub-network 824 and a second sub-network 826. In this example, the loss landscape is smoother than the corresponding landscape in FIG. 8A. In FIG. 8B, the gradient 828 for sub-network 824 is in a similar direction to gradient 830 for sub-network 826. Thus, the sub-network gradients are more highly correlated, and a gradient-based search process will perform better and be more stable.

The present disclosure introduces an additional loss function by which the search process is evaluated. The loss function penalizes networks that have steeper loss landscapes in favor of smoother landscapes. In one embodiment, the measure of smoothness is based on the Lipschitz Constant. A function ƒ: Rⁿ→R^{m} the maps length n real vectors to length m real vectors is call Lipschitz continuous if there exists a constant C such that:

∀ x, y∈Rⁿ, ∥ƒ(x)−ƒ(y)∥₂≥C∥x−y∥₂,

where x, y are inputs and ƒ(x), ƒ(y) are corresponding outputs. ∥ . . . ∥₂ indicates a L2 vector norm. A lower value of the Lipschitz constant (C) indicates a smoother or flatter function f. The mechanism disclosed here biases the architecture search to minimize the Lipschitz constant of all sub-networks in a weight-sharing NAS.

Neural networks are generally non-convex functions, so computing their exact Lipschitz constant is not practical. Consequently, the approach uses approximations to the Lipschitz constant, for each layer in a given sub-network. Given a linear layer with weight matrix W, the L2-norm based Lipschitz constant is given by the maximum singular value σₘₐₓ of the matrix. Calculation of a singular value decomposition of large matrix is computationally very expensive.

In one embodiment, the maximum singular value for a square matrix W is estimated as:
1. x₀: a random Gaussian vector.
2. For n from 1 to N:
3. xₙ=W*Xₙ₋₁

$$4. {σ}_{max} \approx \frac{{\vert {x}_{N} \vert}_{2}}{{\vert {x}_{N - 1} \vert}_{2}}$$

For a non-square matrix W, the maximum singular value is estimated as:
1. x₀: a random Gaussian vector.
2. For n from 1 to N:
3. xₙ=W^{T}W*Xₙ₋₁

$$4. {σ}_{max} \approx {( \frac{{\vert {x}_{N} \vert}_{2}}{{\vert {x}_{N - 1} \vert}_{2}} )}^{1 / 2}$$

The maximum singular value σₘₐₓ is a measure of the lack of smoothness, in that a weight matrix with a smaller maximum singular value is smoother than one with a larger value. The Lipschitz loss function for each sub-network is added to the conventional output-error loss, such a cross-entropy loss, Loss_{CE}. In this way, we minimize approximate Lipschitz constants of each sub-network during the search process of weight-sharing NAS. The final loss function is:

$$Loss = {\sum }_{each subnetwork} ( {Loss}_{CE} + λ {\sum }_{layer i} {σ}_{max}^{i} )$$

where the first loss, Loss_{CE}, is a cross-entropy loss for a given training input and sub-network and the second loss, λΣ_{layer i}σₘₐₓⁱ, is a sum, over layers of the sub-network, of estimates of the maximum singular value of the weight matrix for the layer. λ is a smoothness scale factor that determines the relative importance of the first and second loss terms.

Thus, the final loss function is based, at least in part, on a measure of the smoothness of the sub-network.

In one embodiment the above loss function is minimized jointly for multiple sub-networks for the same batch of training data. This biases each sub-network to having greater smoothness. In turn, this helps to achieve better training convergence and higher accuracy during weight-sharing NAS. The inclusion of the second term recognizes that smoothness with respect to sub-network weights can contribute to the stability of neural architecture search.

```
Pseudo-code Listing:
    Input: training steps n, search space S, Super-Net parameters Θ,
    Data loader D, loss function Loss, smoothing scale factor λ, Number
    of sample networks: m
    for j = 1 to n do
        for data, labels in D do
            reset Loss = 0
            for k = 1 to m do
                Sample modelₖ from S, extract the parameters Θₖ
                from Θ
                Calculate Loss for modelₖ based on Θₖ, data, labels
                and λ:
                    ${Loss}_{k} = {Loss}_{CE} + λ {\sum }_{layer i} {σ}_{max}^{i}$
                Accumulate loss values: Loss = Loss + Lossₖ
            end for
            Calculate gradient of sampled parameters for accumulated
            Loss
            Update parameters Θ by gradients.
        end for
    end for
```

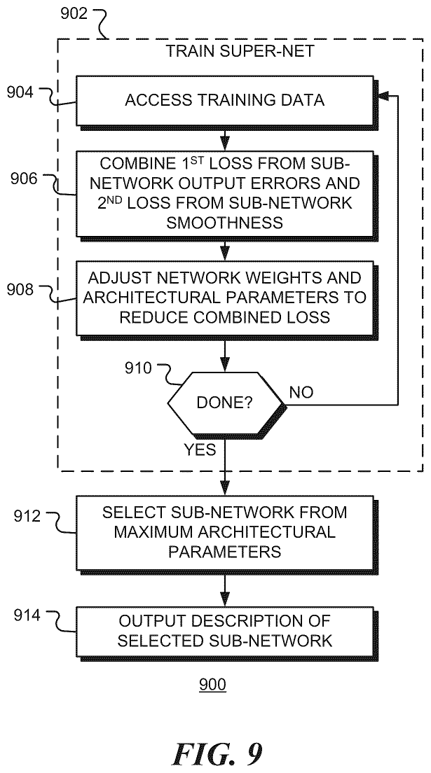

FIG. 9 is a flow chart of a computer-implemented method 900 of automated design of a neural network. At block 902, network weights and architecture parameters of a super-net are trained for a designated task. The super-net includes a plurality of sub-networks that may share network weights. In one embodiment, the training includes accessing one or more training inputs and corresponding training outputs from a batch of training data at block 904. At block 906, first and second losses are computed and combined over a sample of sub-networks to produce an accumulated loss. The first loss is based on a difference between the output of a sub-network, generated from the training input, and the corresponding training output. The second loss is determined from a sum, over layers of the sub-network, of measures of a lack of smoothness, based on network weights in the layers. At block 908, network weights and architectural parameters of the super-net are adjusted to reduce the accumulated loss. If more training data is accessed, as depicted by the negative branch from decision block 910, flow returns to block 904. Otherwise, as depicted by the positive branch from decision block 910, the training is complete, and flow continues to block 912. At block 912, a sub-network of the plurality of sub-networks is selected dependent upon the adjusted architectural parameters. A description of the selected sub-network is output at block 914. This may be used, for example, to configure a programmable neural network or provide design parameters for custom hardware. The weights of the selected sub-network may be retrained, or further trained, to provide improved performance, as described above with reference to FIG. 2.

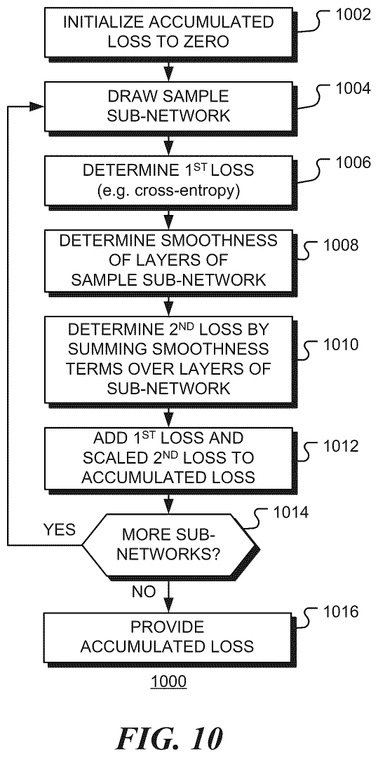

FIG. 10 is a flow chart of a computer-method 1000 of determining a loss function dependent upon the lack of smoothness of sub-network layers in a neural network. At block 1002, an accumulated loss is set to zero. At block 1004, a sample sub-network is drawn from a super-net. At block 1006, a first loss is determined from the difference between the output of the sub-network, generated from a training input, and a training output corresponding to the training input. This may be a cross-entropy loss, for example. At block 1008, the smoothness, or lack thereof, is determined for layers of the sample sub-network. At block 1010, a second loss is determined by summing the smoothness (or lack thereof) over layers of the sample network. The first loss is combined with a weighted second loss and added to the accumulated loss at block 1012. Once a designated number of sample sub-networks has been drawn from the super-net, as depicted by the negative branch from decision block 1014, the computation is complete, and the accumulated loss is output at block 1016. If more sample sub-networks are to be considered, as depicted by the positive branch from decision block 1014, flow returns to block 1004. The accumulated loss may be used to train the super-net, adjust the architecture parameters, and/or select a sub-network.

In the example results described below, super-nets are constructed for an AttentiveNAS-like search spaces, and two examples are considered.

AttentiveNAS-like (Super-net A), in which the super-net includes 17 Inverted Bottle-Neck (IBN) blocks that were first introduced in the MobileNet-V2 model. For each of convolution layer, a search is performed over 2-4 options for the number of output channels and two options of the kernel size ({3×3}, {5×5}) for the depth-wise convolution layers.

AttentiveNAS-like (Super-net B) where the super-net includes up to 15 IBN blocks. For each of the convolution layer, a search is performed over 7 options for number of output channels, and the layer/block type is selected to be an IBN block, an average pooling layer or a fused convolution layer for the {1, 6, 11 }block of the super-net.

Search of the architecture space is performed using α-parameter, to learn the optimal architecture, and using the weight-sharing mechanism introduced by Single Path NAS.

The standard training datasets CIFAR-10/CIFAR-100 are used to adjust the weights and architecture parameters and to evaluate the architecture found by the search. Each dataset is divided into a number of data batches. In each training epoch, the super-net is trained using all of the data batches in the dataset.

A Stochastic Gradient Descent (SGD) optimizer, with momentum 0.9, is used to train the super-net for 60 epochs. In each training step, a batch of training data is accessed and used to adjust the weights and architecture parameters. Cosine Annealing learning scheduling is used to tune the learning rate.

For super-net A, four sub-networks are sampled on the same training batch with batch size 500 and the aggregated gradient is used to update the parameters. For super-net B, the batch size is 250 and a single sample sub-network is used for every training batch. The aggregated gradient for every four training batches is used to update the weights and architecture parameters.

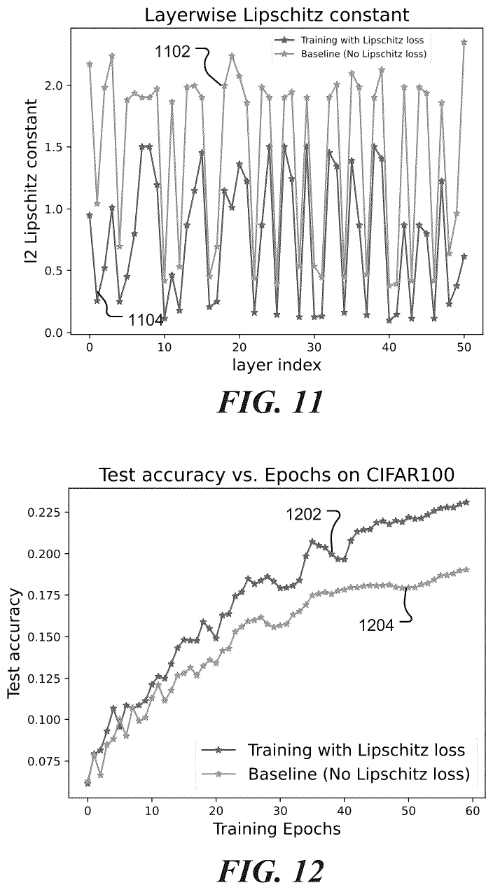

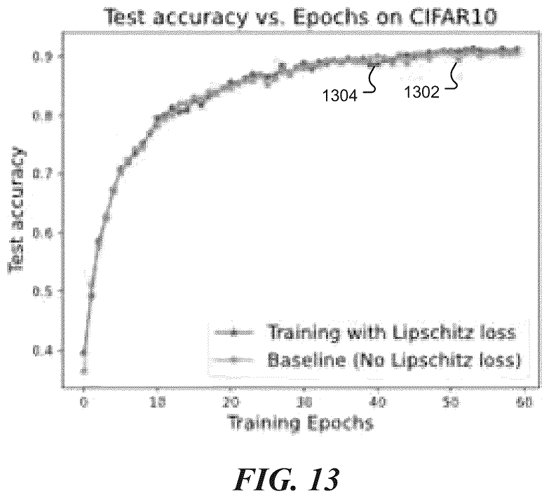

FIGS. 11 and 12 show results for super-net A trained on the CIFAR-100 dataset. For the baseline results, the super-net was trained using a cross-entropy (CE) loss only (i.e., no smoothness loss function). For the results trained using both first (CE) and second (Lipschitz) losses (referred to as SmoothNAS), the smoothness scale factor was set as λ=10.

FIG. 11 shows the estimated Lipschitz constant for layers of the trained network. Line 1102 shows the Lipschitz constant for layers trained using baseline training, while line 1104 shows the Lipschitz constant for the layers trained using SmoothNAS. The SmoothNAS approach produces the desired result of increased smoothness which is indicated by a smaller Lipschitz constant.

FIG. 12 shows the test accuracy of networks, trained by the baseline NAS and SmoothNAS, as a function of training epoch number. The use of the Lipschitz loss function, line 1202, results in faster convergence and 4% higher accuracy than the baseline trained network, line 1204. These results indicate that the gradient properties are significantly improved.

Hardware-aware NAS: In a further example, networks were trained using the CIFAR-10 dataset. In addition, the number of parameters was introduced as another loss term for both SmoothNAS and baseline methods. The objective was to create a hardware-aware NAS with a reduced number of parameters while simultaneously training the super-net.

Table 1 shows result of hardware-aware NAS for super-net B on the CIFAR-10 dataset. The results indicate that training with the disclosed Lipschitz loss function provided better test performance (0.95% higher accuracy) and required less computation (1.9M fewer floating-point operations per second).

TABLE 1

| Method | Number of Parameters | FLOPS | Test Accuracy |
|---|---|---|---|
| Baseline | 100K | 36.8M | 83.80% |
| (No Lipschitz Loss) | | | |
| SmoothNAS | 100K | 34.9M | 84.75% |

The results illustrate that SmoothNAS is also applicable and effective under a hardware-aware NAS setup. In particular, SmoothNAS results in a similar hardware cost but achieves higher test accuracy.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. A computer-implemented method comprising:
training network weights and architecture parameters of a super-net including a plurality of sub-networks, the training including:
for a plurality of training inputs and corresponding training outputs in training data:
accumulating a loss over a sample of sub-networks, the accumulated loss based, at least in part, on a sum, over layers of a sub-network, of measures of smoothness that is based on network weights in the layers; and
adjusting network weights and architectural parameters of the super-net to reduce the accumulated loss.

2. The computer-implemented method of claim 1, further comprising:
selecting a sub-network of the plurality of sub-networks based on the adjusted architectural parameters;
outputting a description of the selected sub-network;
training network weights of the selected sub-network using the training data; and
outputting the trained network weights.

3. The computer-implemented method of claim 2, where:
the accumulated loss includes a first loss and a second loss;
the first loss is based on a difference between an output of a sample sub-network, generated from a training input, and a corresponding training output; and
the second loss is a product of a smoothness scale factor and the sum, over layers of the sample sub-network, of measures of smoothness.

4. The computer-implemented method of claim 3, where:
the second loss for sub-network k is:
Loss_{2, k}=λΣ_{layer j} σₘₐₓ (W_{k, j}); and
λ is a smoothness scale factor, W_{k, j} is a matrix of network weights in layer j of sub-network k and σₘₐₓ (W_{k, j}) is the maximum singular of the matrix W_{k, j} or an estimate thereof.

5. The computer-implemented method of claim 2, where:
the accumulated loss includes a first loss and a second loss;
the first loss is determined based on a difference between an output of a sample sub-network, generated from a training input, and a corresponding training output; and
the second loss is determined by:
for each layer of the sub-network, computationally estimating a maximum singular value of a matrix of network weights of the layer, and
accumulating the estimated maximum singular values over layers of a sub-network.

6. The computer-implemented method of claim 2, where the measure of smoothness of a layer of a sub-network is based on an estimate of the maximum ratio between variations in the output from the layer and variations in the input to the layer.

7. The computer-implemented method of claim 2, where said adjusting the architectural parameters and the network weights includes:
determining gradients of the accumulated loss functions; and
updating the architectural parameters and the network weights of the super-net based on the gradients.

8. The computer-implemented method of claim 7, where the network weights of the super-net are shared with one or more sub-networks of the plurality of sub-networks.

9. A system comprising at least one processor configured to:
train network weights and architecture parameters of a super-net including a plurality of sub-networks, including:
for a plurality of training inputs and corresponding training outputs:
accumulate a loss over a sample of sub-networks, the accumulated loss based, at least in part, on a sum, over layers of sub-networks in the sample, of measures of smoothness based on network weights in the layers; and
adjust the architectural parameters and network weights of the super-network to reduce the accumulated loss;

10. The system of claim 9, where the processor is further configured to:
select a sub-network of the plurality of sub-networks based on the adjusted architectural parameters;
output a description of the selected sub-network;
train network weights of the selected sub-network using the training data; and
output the trained network weights.

11. The system of claim 10, where:
the accumulated loss includes a first loss and a second loss;
the first loss is based on a difference between an output of a sample sub-network, generated from a training input, and a corresponding training output; and
the second loss is a product of a smoothness scale factor and the sum, over layers of the sample sub-network, of measures of smoothness.

12. The system of claim 11, where:
the second loss for sub-network k is:
Loss_{2, k}=λΣ_{layer j} σₘₐₓ (W_{k, j}); and
λ is a smoothness scale factor, W_{k, j} is a matrix of network weights in layer j of sub-network k and σₘₐₓ (W_{k, j}) is the maximum singular of the matrix W_{k, j} or an estimate thereof.

13. The system of claim 10, where said adjust the architectural parameters and the network weights includes:
determine gradients of the accumulated loss function, and
update the architectural parameters and the network weights of the super-net dependent upon the computed gradients.

14. The system of claim 13, where the network weights of the super-net are shared with one or more sub-networks of the plurality of sub-networks.

15. A data processor comprising:
a super-net including a plurality of selectable sub-networks, the super-net including network weights and architecture parameters;
a data loader configured to access training data for a designated task; and
a supervised learning controller configured to train network weights and architectural parameters of the super-net, including:
provide training inputs of the training data to sample sub-networks of the super-net to generate sub-network outputs,
accumulate a loss over the sample of sub-networks, the accumulated loss based, at least in part, on a sum, over layers of sub-networks in the sample, of measures of smoothness based on network weights in the layers, and
adjust the architectural parameters and network weights of the super-network to reduce the accumulated loss.

16. The data processor of claim 15, where the supervised learning controller is further configured to:
select a sub-network of the plurality of sub-networks based on the adjusted architectural parameters;
output a description of the selected sub-network;
train network weights of the selected sub-network using the training data; and
output the trained network weights.

17. The data processor of claim 16, where:
the accumulated loss includes a first loss and a second loss;
the first loss is based on a difference between an output of a sample sub-network, generated from a training input, and a corresponding training output; and
the second loss is a product of a smoothness scale factor and the sum, over layers of the sample sub-network, of measures of smoothness.

18. The data processor of claim 17, where:
the second loss for sub-network k is:
Loss_{2, k}=λΣ_{layer j} σₘₐₓ (W_{k, j}); and
λ is a smoothness scale factor, W_{k, j} is a matrix of network weights in layer j of sub-network k and σₘₐₓ (W_{k, j}) is the maximum singular of the matrix W_{k, j} or an estimate thereof.

19. The data processor of claim 16, where said adjust the architectural parameters and the network weights includes:
determine gradients of the accumulated loss function, and
update the architectural parameters and the network weights of the super-net dependent upon the computed gradients.

20. The data processor of claim 19, where the network weights of the super-net are shared with one or more sub-networks of the plurality of sub-networks.
